(19) United States
(12) Patent Application Publication
(10) Pub. No.: US 2026/0277837 A1
(43) Pub. Date: Sep. 17, 2026

(54) Inter-Die communication subsystem

(71) Applicant: Marvell Asia Pte Ltd, Singapore (SG)

(72) Inventors: Kazin Simon Blacklow, Burlington, VT (US); John Edward Gregory, JR., Dummerston, VT (US); Sidney William Allman, Stittsville (CA); Zachary Baldwin, Burlington, VT (US); Ting Zheng, San Jose, CA (US); Aatreya Chakravarti, Winooski, VT (US); Carlos Macian Ruiz, Los Gatos, CA (US); Samer Akiki, Redwood City, CA (US); Joshua F. Dillon, Stowe, VT (US); Mark William Kuemerle, Essex Junction, VT (US); Wolfgang Sauter, Starksboro, VT (US)

(21) Appl. No.: 19/562,877

(22) Filed: Mar. 11, 2026

Related U.S. Application Data
(60) Provisional application No. 63/770,935, filed on Mar. 12, 2025.

(51) Int. Cl. G06F 13/36

(52) U.S. Cl. CPC G06F 13/36; G06F 2213/40

(57) ABSTRACT

A system includes (a) a first die including a first die core and a first die-to-die (D2D) subsystem, (b) a second die including a second D2D subsystem, the first D2D subsystem includes: (i) a plurality of first D2D physical interfaces (PHYs), each first D2D PHY including a plurality of data lanes, and (ii) a first elastic buffer configured to aggregate bandwidth from the plurality of first D2D PHYs, the first elastic buffer is configured to provide a single interface between the first die core and the plurality of first D2D PHYs, and (c) a D2D link coupling the plurality of first D2D PHYs to the second D2D subsystem, the first elastic buffer is configured to enable compensation for a failed data lane in one of the plurality of first D2D PHYs by redistributing data transmission across remaining functional data lanes in the plurality of first D2D PHYs.

### CROSS-REFERENCE TO RELATED APPLICATIONS

This application claims the benefit of U.S. Provisional Patent Application 63/770,935, filed Mar. 12, 2025, whose disclosure is incorporated herein by reference.

### FIELD OF THE DISCLOSURE

The present disclosure relates generally to inter-die communication in multi-die semiconductor systems, and more particularly but not exclusively to die-to-die subsystems for managing data transfer between dies.

### BACKGROUND

Semiconductor systems increasingly employ multi-die architectures to achieve higher performance, greater bandwidth, and improved scalability. These architectures involve multiple semiconductor dies that communicate with one another through die-to-die (D2D) interfaces. Such multi-die systems are prevalent in applications such as artificial intelligence accelerators, high-performance computing systems, and advanced networking equipment.

D2D interfaces facilitate communication between dies within a package or across packages. These interfaces typically comprise multiple physical interface (PHY) blocks, each containing numerous data lanes that collectively provide the bandwidth required for inter-die communication. As system performance demands have grown, the number of D2D lanes employed in modern designs has increased substantially, with some systems utilizing thousands of individual data lanes to achieve the desired bandwidth between dies.

The manufacturing and assembly of multi-die systems involves forming connections between dies, including the D2D interconnects that enable communication. The reliability of these connections affects the overall yield of the assembled system. Various approaches exist for handling connection failures in D2D interfaces, such as redundancy schemes that provide spare lanes to replace failed lanes, and graceful degradation approaches that reduce bandwidth when failures occur.

Redundancy schemes in D2D interfaces typically reserve spare lanes that can be activated when primary lanes fail. Such schemes may be specified in interface standards and can tolerate a limited number of lane failures within a given PHY block. However, these approaches involve tradeoffs between the overhead associated with spare lanes and the coverage provided against different failure patterns.

Graceful degradation approaches allow systems to continue operating with reduced bandwidth when lane failures occur. While these approaches can reduce the overhead associated with spare lanes, they introduce complexity in managing variable bandwidth availability across the system.

Therefore, there is a general interest in approaches for managing D2D communication in multi-die systems.

The description above is presented as a general overview of related art in this field and should not be construed as an admission that any of the information it contains constitutes prior art against the present patent application.

### SUMMARY

An embodiment that is described herein provides a system including (a) a first die including a first die core and a first die-to-die (D2D) subsystem, (b) a second die including a second D2D subsystem, the first D2D subsystem includes: (i) a plurality of first D2D physical interfaces (PHYs), each first D2D PHY including a plurality of data lanes, and (ii) a first elastic buffer configured to aggregate bandwidth from the plurality of first D2D PHYs, the first elastic buffer is configured to provide a single interface between the first die core and the plurality of first D2D PHYs, and (c) a D2D link coupling the plurality of first D2D PHYs to the second D2D subsystem, the first elastic buffer is configured to enable compensation for a failed data lane in one of the plurality of first D2D PHYs by redistributing data transmission across remaining functional data lanes in the plurality of first D2D PHYs.

In some embodiments, the first elastic buffer includes a transmit elastic buffer configured to receive data from the first die core and provide the data to the plurality of first D2D PHYs. In other embodiments, the first D2D subsystem further includes a receive elastic buffer configured to receive data from the plurality of first D2D PHYs and provide the data to the first die core. In yet other embodiments, the first elastic buffer is configured to allow data to be written at a first clock frequency associated with the first die core and read at a second clock frequency associated with the plurality of first D2D PHYs.

In some embodiments, the first clock frequency and the second clock frequency differ in at least one of phase and frequency. In other embodiments, each of the plurality of first D2D PHYs is configured to operate at an independent rate based on a negotiated operating bandwidth. In yet other embodiments, the first elastic buffer is configured to maintain aggregate bandwidth from the plurality of first D2D PHYs that meets a bandwidth requirement of the first die core.

In some embodiments, the first D2D subsystem is configured to compensate for a complete failure of one of the plurality of first D2D PHYs by increasing bandwidth of remaining functional first D2D PHYs. In other embodiments, increasing bandwidth of the remaining functional first D2D PHYs includes increasing an operating frequency of the remaining functional first D2D PHYs.

In some embodiments, the second die includes a second die core, and the second D2D subsystem includes: a plurality of second D2D PHYs, each second D2D PHY including a plurality of data lanes, and a second elastic buffer configured to aggregate bandwidth from the plurality of second D2D PHYs and provide a single interface between the second die core and the plurality of second D2D PHYs. In other embodiments, the D2D link is configured to couple the plurality of first D2D PHYs to the plurality of second D2D PHYs for bidirectional communication between the first die and the second die.

There is additionally provided, in accordance with an embodiment that is described herein, a method for inter-die communication in a system including a first die and a second die, the method including receiving, at a first elastic buffer of a first die-to-die (D2D) subsystem, data from a first die core. The data is distributed from the first elastic buffer to a plurality of first D2D physical interfaces (PHYs), each first D2D PHY including a plurality of data lanes. The data is transmitted via the plurality of first D2D PHYs to a second D2D subsystem of the second die through a D2D link. A failure of at least one data lane in one of the plurality of first D2D PHYs is detected, and the failed data lane is compensated for by redistributing data transmission across remaining functional data lanes in the plurality of first D2D PHYs. The first elastic buffer aggregates bandwidth from the plurality of first D2D PHYs to maintain a total aggregate bandwidth that meets a bandwidth requirement of the first die core.

In some embodiments, compensating for the failed data lane includes increasing an operating frequency of the remaining functional data lanes in the plurality of first D2D PHYs. In other embodiments, increasing the operating frequency includes performing a frequency sweep to determine a maximum operating frequency that maintains functionality of the remaining functional data lanes.

In some embodiments, receiving the data at the first elastic buffer includes writing the data at a first clock frequency associated with the first die core, and distributing the data from the first elastic buffer includes reading the data at a second clock frequency associated with the plurality of first D2D PHYs, the first clock frequency and the second clock frequency differ in at least one of phase and frequency. In other embodiments, the method further includes compensating for a complete failure of one of the plurality of first D2D PHYs by increasing bandwidth of remaining functional first D2D PHYs in the plurality of first D2D PHYs.

There is further provided, in accordance with an embodiment that is described herein, a die-to-die (D2D) subsystem for a die in a multi-die system, the D2D subsystem includes: (a) a plurality of D2D physical interfaces (PHYs), each D2D PHY including a plurality of data lanes configured to transmit data to another die, (b) an elastic buffer for transmission configured to receive data from a die core and provide the data to the plurality of D2D PHYs, and (c) an elastic buffer for reception configured to receive data from the plurality of D2D PHYs and provide the data to the die core. The elastic buffer for transmission is configured to aggregate bandwidth from the plurality of D2D PHYs such that the plurality of D2D PHYs operate as a single endpoint for the die core, and the D2D subsystem is configured to compensate for a failure of at least one data lane by redistributing data transmission across remaining functional data lanes in the plurality of D2D PHYs.

In some embodiments, each of the plurality of D2D PHYs is configured to operate at an independent clock frequency based on a negotiated operating bandwidth. In other embodiments, the D2D subsystem is configured to compensate for the failure of the at least one data lane by increasing an operating frequency of the remaining functional data lanes. In yet other embodiments, the D2D subsystem is configured to compensate for a complete failure of one of the plurality of D2D PHYs by increasing bandwidth of remaining functional D2D PHYs in the plurality of D2D PHYs.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a multi-die system comprising dies configured for inter-die communication, in accordance with an embodiment that is described herein; and

FIG. 2 is a flowchart that schematically illustrates a method for inter-die communication, in accordance with an embodiment that is described herein.

### DETAILED DESCRIPTION OF EMBODIMENTS

### Overview

Multi-die semiconductor systems increasingly rely on die-to-die (D2D) interfaces to achieve the high bandwidth required for applications such as artificial intelligence accelerators and high-performance computing systems. These systems may employ thousands of individual D2D lanes distributed across numerous D2D physical interface (PHY) blocks to provide the necessary inter-die communication bandwidth. However, the large number of connections required presents significant challenges for manufacturing yield, as the failure of even a single lane can render an entire assembled module non-functional, resulting in the loss of expensive components such as but not limited to high-bandwidth memory, interposers, and advanced node chiplets.

Conventional approaches to addressing D2D lane failures include redundancy schemes that reserve spare lanes within each PHY block to replace failed lanes. While such schemes can tolerate a limited number of failures, they impose area overhead proportional to the number of tolerable failures and may only be able to repair certain types, patterns, or numbers of failures within a given PHY. For example, if two failures occur within the same PHY block that has only one spare lane, the redundancy scheme is overwhelmed and the system fails, even if other PHY blocks in the system have unused spare capacity. Graceful degradation approaches that reduce bandwidth when failures occur can reduce overhead but introduce complexity in managing variable bandwidth availability and may not meet the consistent bandwidth requirements expected by system designers.

Embodiments of the present disclosure that are described herein address these challenges by providing a D2D subsystem architecture that employs elastic buffers to aggregate bandwidth from multiple D2D PHYs, enabling repair, compensation and redundancy across the entire D2D subsystem rather than being limited to individual PHY blocks. In some embodiments, the D2D subsystem comprises a transmit elastic buffer and a receive elastic buffer configured to provide a single interface between the die core and the plurality of D2D PHYs, allowing the collection of PHYs to operate as a single endpoint from the perspective of the die core.

In some embodiments, the elastic buffers accommodate differences in clock phase and frequency between the die core and the individual D2D PHYs, enabling each PHY to operate at an independent rate based on its negotiated operating bandwidth. In an example implementation, when a data lane fails in one PHY, the system compensates by redistributing data transmission across remaining functional data lanes in the plurality of PHYs, and when an entire PHY fails, the remaining functional PHYs increase their bandwidth to maintain the aggregate bandwidth required by the die core.

The disclosed techniques advantageously provide subsystem-level redundancy that enable any functional lane within the D2D subsystem to compensate for failures in any other lane, regardless of which PHY block contains the failure. This broader repair and compensation capability significantly improves the effectiveness of redundancy compared to per-PHY schemes, as the probability of multiple failures occurring in the same PHY is substantially lower than the probability of failures being distributed across different PHYs. The disclosed architecture is configured to maintain a consistent bandwidth interface to the die core while accommodating variations in individual PHY performance, thereby avoiding the complexity that graceful degradation approaches impose on system designers. Additionally, the same infrastructure that enables compensation for failures can be utilized to maximize bandwidth or minimize power consumption through frequency and voltage optimization across the D2D subsystem.

The description above is presented as a general overview of embodiments of the present disclosure, which are described in detail herein.

### Definitions

In the present context, the term “die” may refer to a discrete piece of semiconductor material, typically silicon, on which integrated circuits are fabricated. A die may contain processing cores, memory, interface circuitry, or other functional blocks. For example, a die may be a processor chiplet in a multi-chip module or a high-bandwidth memory die in an advanced package.

In the present context, the term “die core” may refer to the primary functional circuitry within a die that performs computational, memory, or other processing operations and that interfaces with communication subsystems for data transfer. For example, a die core may be a central processing unit (CPU) core, a graphics processing unit (GPU) core, or an artificial intelligence (AI) accelerator core that generates and consumes data transmitted through die-to-die interfaces.

In the present context, the term “die-to-die (D2D) subsystem” may refer to a collection of circuitry within a die that manages communication with one or more other dies, such as but not limited to physical interfaces, buffers, and associated control logic. For example, a D2D subsystem may aggregate multiple physical interface blocks and elastic buffers to provide a unified communication interface between a die core and external dies.

In the present context, the term “die-to-die physical interface” or “D2D PHY” may refer to a circuit block that implements the physical layer functions for transmitting and receiving data between dies, such as but not limited to signal drivers, receivers, and serialization/deserialization logic. For example, a D2D PHY may contain multiple data lanes that collectively provide a portion of the total bandwidth between two dies in a multi-die system.

In the present context, the term “data lane” may refer to an individual signal path within a physical interface that carries data between dies, typically comprising transmit and receive circuitry for bidirectional communication. For example, a data lane may be one of sixty-four lanes within a D2D PHY that collectively provide the bandwidth specified by an interface standard.

In the present context, the term “elastic buffer” may refer to a memory structure that accommodates differences in clock phase and frequency between a data producer and a data consumer by temporarily storing data and allowing asynchronous read and write operations. For example, an elastic buffer may receive data from a die core operating at one clock frequency and provide that data to multiple D2D PHYs operating at different clock frequencies.

In the present context, the term “transmit elastic buffer” or “elastic buffer for transmission” may refer to an elastic buffer configured to receive data from a die core for transmission to other dies and to distribute that data to one or more D2D PHYs. For example, a transmit elastic buffer may aggregate outgoing data from a processor core and make it available to multiple D2D PHYs that pull data at their respective operating rates.

In the present context, the term “receive elastic buffer” or “elastic buffer for reception” may refer to an elastic buffer configured to receive data from one or more D2D PHYs and provide that data to a die core. For example, a receive elastic buffer may collect incoming data from multiple D2D PHYs operating at different rates and present a unified data stream to a processor core.

In the present context, the term “D2D link” may refer to the physical interconnection between D2D PHYs on different dies that enables data transfer between the dies. For example, a D2D link may comprise bump connections, through-silicon vias, or other interconnect structures that couple the transmit ports of PHYs on one die to the receive ports of PHYs on another die.

In the present context, the term “aggregate bandwidth” may refer to the total data transfer capacity provided by combining the bandwidth contributions of multiple D2D PHYs or data lanes within a D2D subsystem. For example, if four D2D PHYs each provide 100 gigabytes per second of bandwidth, the aggregate bandwidth of the D2D subsystem is 400 gigabytes per second.

In the present context, the term “bandwidth requirement” may refer to the minimum data transfer rate that a die core requires from a D2D subsystem to maintain proper system operation. For example, a bandwidth requirement may specify that a D2D subsystem must provide at least 1 terabyte per second of aggregate bandwidth to support the data throughput demands of an AI accelerator.

In the present context, the term “negotiated operating bandwidth” may refer to the data transfer rate established between communicating D2D PHYs through a handshaking or training process that determines the operational parameters of the link. For example, a negotiated operating bandwidth may be determined during link initialization when two PHYs exchange information about their capabilities and agree on a common operating frequency.

In the present context, the term “operating frequency” may refer to the clock rate at which a D2D PHY or data lane transmits and receives data. For example, an operating frequency may be increased from 2 gigahertz to 2.2 gigahertz to compensate for a failed data lane by providing additional bandwidth through the remaining functional lanes.

In the present context, the term “clock frequency” may refer to the rate of a periodic signal used to synchronize data transfers within a circuit or between circuits. For example, a first clock frequency associated with a die core may differ from a second clock frequency associated with D2D PHYs, with an elastic buffer accommodating the difference.

In the present context, the term “single interface” may refer to a unified connection point that abstracts the complexity of multiple underlying components, presenting them as one logical entity to other parts of the system. For example, an elastic buffer may provide a single interface between a die core and multiple D2D PHYs, allowing the die core to interact with the D2D subsystem without managing individual PHY operations.

In the present context, the term “single endpoint” may refer to a logical termination point for data communication that represents multiple physical interfaces as one unified entity. For example, a D2D subsystem may present multiple D2D PHYs as a single endpoint to a die core, simplifying the interface and hiding the distribution of data across individual PHYs.

In the present context, the term “repair” may refer to the process of compensating for a failed component by utilizing remaining functional components to maintain system operation. For example, repair of a failed data lane may involve redistributing data transmission across remaining functional data lanes to maintain the required aggregate bandwidth.

In the present context, the term “failed data lane” may refer to a data lane that is unable to reliably transmit or receive data due to manufacturing defects, connection failures, or other faults. For example, a failed data lane may result from a defective bump connection between dies that prevents signal transmission.

In the present context, the term “functional data lane” or “remaining functional data lane” may refer to a data lane that is capable of reliably transmitting and receiving data and that can be utilized to compensate for failed data lanes. For example, remaining functional data lanes in a D2D PHY may increase their operating frequency to maintain aggregate bandwidth when one data lane fails.

In the present context, the term “complete failure” when referring to a D2D PHY may refer to a condition in which all data lanes within the PHY are non-functional or the PHY is otherwise unable to participate in data transfer. For example, a complete failure of a D2D PHY may occur when a manufacturing defect affects the entire PHY block, requiring other PHYs in the D2D subsystem to compensate for the lost bandwidth.

In the present context, the term “frequency sweep” may refer to a testing procedure that evaluates system operation across a range of operating frequencies to determine optimal or maximum functional frequencies. For example, a frequency sweep may test D2D PHY operation from a low frequency up to a maximum frequency to identify the highest frequency at which all functional data lanes operate reliably.

In the present context, the term “multi-die system” may refer to a semiconductor system comprising two or more dies that communicate with one another through inter-die interfaces. For example, a multi-die system may comprise a processor die and a memory die within a single package, or multiple processor chiplets connected through D2D links.

In the present context, the term “bidirectional communication” may refer to data transfer capability in both directions between two entities, enabling each entity to both transmit and receive data. For example, bidirectional communication between a first die and a second die allows the first die to send data to the second die and receive data from the second die through the same D2D link.

### System Description

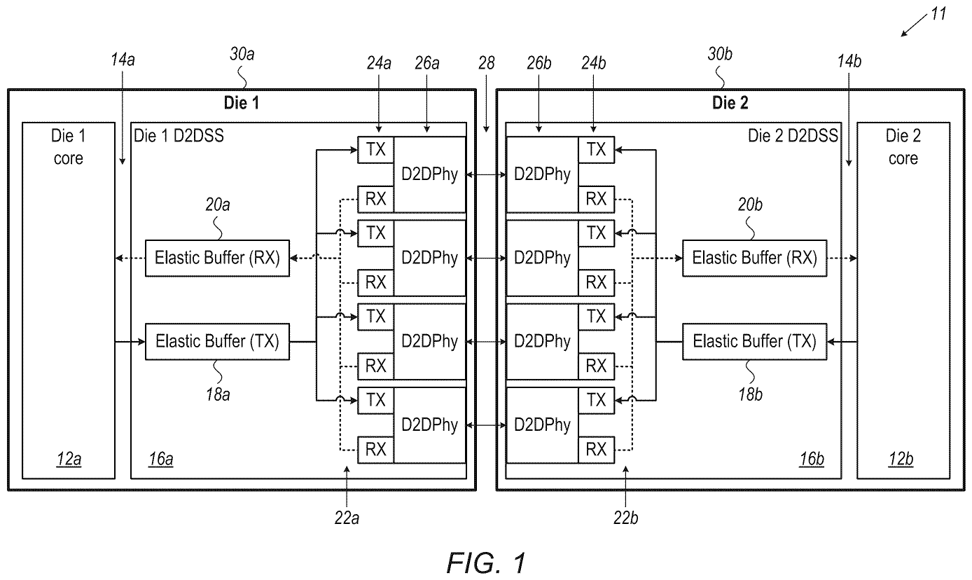

FIG. 1 is a block diagram that schematically illustrates a system 11 comprising dies configured for inter-die communication, in accordance with an embodiment that is described herein. In some embodiments, system 11 comprises a first die 30a and a second die 30b. First die 30a comprises a first die core 12a and a D2D subsystem 16a of first die 30a. Second die 30b comprises a second die core 12b and a D2D subsystem (D2DSS) 16b of second die 30b. First die core 12a is coupled to D2D subsystem 16a of first die 30a through intra-die interconnects 14a. Second die core 12b is coupled to D2D subsystem 16b of second die 30b through intra-die interconnects 14b.

In some embodiments, D2D subsystem 16a comprises a plurality of first D2D Physical Interfaces (PHYs) 26a. Each of first D2D PHYs 26a comprises a plurality of data lanes configured to transmit and receive data. First D2D PHYs 26a comprise transmitter (TX) and receiver (RX) ports 24a of first D2D PHYs 26a for transmitting and receiving data. TX and RX ports 24a of first D2D PHYs 26a are coupled to first intra-die links 22a. Similarly, D2D subsystem 16b of second die 30b comprises a plurality of second D2D PHYs 26b. Each of second D2D PHYs 26b comprises a plurality of data lanes. Second D2D PHYs 26b comprise TX and RX ports 24b of second D2D PHYs 26b coupled to second intra-die links 22b.

In some embodiments, D2D subsystem 16a further comprises a first elastic buffer of transmitter 18a and a first elastic buffer of receiver 20a. The terms first elastic buffer of transmitter and first elastic buffer of receiver refer to elastic buffers 18a and 20a of the transmitter and receiver, respectively. First elastic buffer of transmitter 18a is configured to receive data from first die core 12a via intra-die interconnects 14a and provide the data to first D2D PHYs 26a through first intra-die links 22a. First elastic buffer of receiver 20a is configured to receive data from first D2D PHYs 26a through first intra-die links 22a and provide the data to first die core 12a. In some embodiments, first elastic buffer of transmitter 18a is configured to aggregate bandwidth from the plurality of first D2D PHYs 26a. First elastic buffer of transmitter 18a provides a single interface between first die core 12a and the plurality of first D2D PHYs 26a.

In some embodiments, D2D subsystem 16b of second die 30b comprises a second elastic buffer of transmitter 18b and a second elastic buffer of receiver 20b. Second elastic buffer of transmitter 18b is configured to receive data from second die core 12b via intra-die interconnects 14b and provide the data to second D2D PHYs 26b through second intra-die links 22b. Second elastic buffer of receiver 20b is configured to receive data from second D2D PHYs 26b through second intra-die links 22b and provide the data to second die core 12b. Second elastic buffer of transmitter 18b is configured to aggregate bandwidth from the plurality of second D2D PHYs 26b and provide a single interface between second die core 12b and the plurality of second D2D PHYs 26b.

In some embodiments, a D2D link 28 is configured to couple first D2D PHYs 26a to second D2D PHYs 26b. D2D link 28 is configured to enable bidirectional communication between first die 30a and second die 30b. D2D link 28 couples the plurality of first D2D PHYs 26a to the plurality of second D2D PHYs 26b for bidirectional communication, allowing first die 30a to send data to second die 30b and receive data from second die 30b through the same D2D link 28. D2D link 28 comprises bump connections, through-silicon vias, or other interconnect structures that couple the transmit ports of first D2D PHYs 26a to the receive ports of second D2D PHYs 26b and vice versa.

In some embodiments, first elastic buffer of transmitter 18a is configured to enable repair of (i.e., compensate for) a failed data lane in one of the plurality of first D2D PHYs 26a by redistributing data transmission across remaining functional data lanes in the plurality of first D2D PHYs 26a. This subsystem-level redundancy allows any functional lane within D2D subsystem 16a to compensate for failures in any other lane, regardless of which PHY block contains the failure. The probability of multiple failures occurring in the same PHY is much lower than the probability of failures being distributed across different PHYs, making this broader repair capability significantly more effective than per-PHY redundancy schemes.

In some embodiments, first elastic buffer of transmitter 18a is configured to allow data to be written at a first clock frequency associated with first die core 12a and read at a second clock frequency associated with the plurality of first D2D PHYs 26a. The first clock frequency and the second clock frequency differ in at least one of phase and frequency. This configuration enables asynchronous clock domain crossing between first die core 12a and first D2D PHYs 26a. First elastic buffer of transmitter 18a accommodates differences in clock phase and frequency by temporarily storing data and allowing asynchronous read and write operations.

In some embodiments, each of the plurality of first D2D PHYs 26a is configured to operate at an independent rate based on a negotiated operating bandwidth. The negotiated operating bandwidth is established between communicating D2D PHYs through a handshaking or training process that determines the operational parameters of the link. First elastic buffer of transmitter 18a is configured to maintain aggregate bandwidth from the plurality of first D2D PHYs 26a that meets a bandwidth requirement of first die core 12a. Each of first D2D PHYs 26a provides a different amount of bandwidth, and as long as the total aggregate bandwidth meets the need of first die core 12a, system 11 remains functional.

In some embodiments, D2D subsystem 16a is further configured to compensate for a complete failure of one of the plurality of first D2D PHYs 26a by increasing bandwidth of remaining functional first D2D PHYs 26a. Increasing bandwidth of the remaining functional first D2D PHYs 26a comprises increasing an operating frequency of the remaining functional first D2D PHYs 26a. In an example, if system 11 comprises 10,000 lanes and one lane fails, the remaining functional lanes increase their frequency by approximately 0.01% to compensate. This approach provides lane repair without the overhead of spare lanes and maintains a consistent bandwidth interface to first die core 12a.

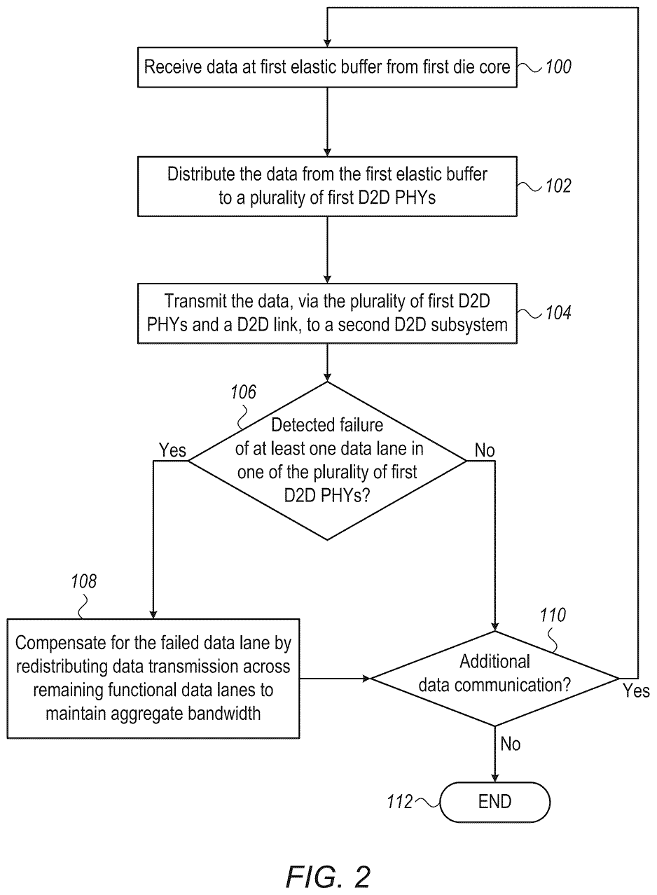

FIG. 2 is a flowchart that schematically illustrates a method for inter-die communication, in accordance with an embodiment that is described herein.

The method begins at a data receiving step 100 with first elastic buffer of transmitter 18a receiving data from first die core 12a. First die core 12a writes data into first elastic buffer of transmitter 18a via intra-die interconnects 14a. First elastic buffer of transmitter 18a temporarily stores the data for distribution to the plurality of first D2D PHYs 26a.

At a data distribution step 102, first elastic buffer of transmitter 18a distributes the data to the plurality of TX ports 24a of first D2D PHYs 26a. Each of first D2D PHYs 26a comprises a plurality of data lanes. TX ports 24a of first D2D PHYs 26a pull data from first elastic buffer of transmitter 18a through first intra-die links 22a at their respective operating rates based on their negotiated operating bandwidth. Subsequently, TX ports 24a of first D2D PHYs 26a send the received data from first elastic buffer of transmitter 18a to first D2D PHYs 26a.

At a data transmission step 104, first D2D PHYs 26a transmit the data to D2D subsystem 16b of second die 30b through D2D link 28. TX ports 24a of D2DPHYs 24a send the data across D2D link 28 to RX and TX ports 24b of second D2D PHYs 24b, respectively. Second D2DPHYs 26b forward the received data to RX ports 24b of first D2D PHYs 26b to second elastic buffer of receiver 20b. Second elastic buffer of receiver 20b provides the data to second die core 12b.

At a first decision step 106, D2D subsystem 16a of first die 30a determines whether a failure of at least one data lane in one of the plurality of first D2D PHYs 26a has been detected. For example, D2D subsystem 16a and D2D subsystem 16b may comprise an error detection and correction scheme using Hamming codes or any other suitable technique. Through this system, if an error has been detected and persists across multiple data transmissions, the D2D subsystem 16a or 16b may determine the data lane to have failed. If D2D subsystem 16a detects a failure (“Yes” branch), the method proceeds to compensation step 108. If D2D subsystem of first die 16a detects no failure (“No” branch), the method proceeds directly to second decision step 110.

At a compensation step 108, D2D subsystem 16a compensates for the failed data lane by redistributing data transmission across remaining functional data lanes in the plurality of first D2D PHYs 26a to maintain aggregate bandwidth. First elastic buffer of transmitter 18a aggregates bandwidth from the plurality of first D2D PHYs 26a to maintain a total aggregate bandwidth that meets a bandwidth requirement of first die core 12a. In some embodiments, compensating for the failed data lane comprises increasing an operating frequency of the remaining functional data lanes. Following compensation step 108, the method proceeds to second decision step 110. As an example, in an embodiment, at least one of D2DSS 16a and 16b (also referred to herein as D2DPHY 26) may comprise four D2D PHYs 26, e.g., D2DPHYs 26a and 26b, respectively. Each D2DPHY 26 may consist of 64 lanes, providing a total of 256 lanes for the present D2DSS 16. A typical data rate for each lane may be 16 gigabits per second (Gbps). This provides an aggregate bandwidth of 4,096 Gbps. In the event of a lane failure (e.g., due to a cracked bump), this reduces the total functional data lanes to 255. To maintain a constant bandwidth across D2D link 28, system 11 must increase the individual bandwidth of each functional data lane to (4,096/255) resulting in approximately 16.06 Gbps. In this embodiment, the individual data lane frequency is increased by about 0.4%.

At a second decision step 110, D2D subsystem 16a determines whether additional data communication is required. If additional data communication is required (“Yes” branch), the method returns to data receiving step 100 to continue the communication process. If no additional data communication is required (“No” branch), the method proceeds to method conclusion step 112.

At a method conclusion step 112, the method for inter-die communication ends. D2D subsystem 16a of first die 30a completes the data transfer process and the system returns to an idle state or proceeds to other operations. It is noted that the method describes data transmission from die first 30a to second die 30b, however, the disclosed techniques are applicable, with necessary changes, to other operations, such as (i) receiving the data by second die 30b, (ii) transmitting another set of data from second die 30b to first die 30a, and (iii) receiving the other set of data by first die 30a.

This particular examples of configuration of system 11 depicted in FIG. 1, and the steps of the method of FIG. 2 are shown by way of example, in order to illustrate certain problems that are addressed by embodiments of the present invention and to demonstrate the application of these embodiments in enhancing the performance of such multi-die system. Embodiments of the present invention, however, are by no means limited to this specific sort of example multi-die system and die-to-die subsystems implemented in dies 30a and 30b, respectively, and the principles described herein may similarly be applied to other sorts of multi-die systems and/or electronic devices.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a first die comprising a first die core and a first die-to-die (D2D) subsystem;
a second die comprising a second D2D subsystem;
wherein the first D2D subsystem comprises:
a plurality of first D2D physical interfaces (PHYs), each first D2D PHY comprising a plurality of data lanes; and
a first elastic buffer configured to aggregate bandwidth from the plurality of first D2D PHYs;
wherein the first elastic buffer is configured to provide a single interface between the first die core and the plurality of first D2D PHYs; and
a D2D link coupling the plurality of first D2D PHYs to the second D2D subsystem;
wherein the first elastic buffer is configured to enable compensation for a failed data lane in one of the plurality of first D2D PHYs by redistributing data transmission across remaining functional data lanes in the plurality of first D2D PHYs.

2. The system according to claim 1, wherein the first elastic buffer comprises a transmit elastic buffer configured to receive data from the first die core and provide the data to the plurality of first D2D PHYs.

3. The system according to claim 2, wherein the first D2D subsystem further comprises a receive elastic buffer configured to receive data from the plurality of first D2D PHYs and provide the data to the first die core.

4. The system according to claim 1, wherein the first elastic buffer is configured to allow data to be written at a first clock frequency associated with the first die core and read at a second clock frequency associated with the plurality of first D2D PHYs.

5. The system according to claim 4, wherein the first clock frequency and the second clock frequency differ in at least one of phase and frequency.

6. The system according to claim 1, wherein each of the plurality of first D2D PHYs is configured to operate at an independent rate based on a negotiated operating bandwidth.

7. The system according to claim 6, wherein the first elastic buffer is configured to maintain aggregate bandwidth from the plurality of first D2D PHYs that meets a bandwidth requirement of the first die core.

8. The system according to claim 1, wherein the first D2D subsystem is configured to compensate for a complete failure of one of the plurality of first D2D PHYs by increasing bandwidth of remaining functional first D2D PHYs.

9. The system according to claim 8, wherein increasing bandwidth of the remaining functional first D2D PHYs comprises increasing an operating frequency of the remaining functional first D2D PHYs.

10. The system according to claim 1, wherein the second die comprises a second die core, and wherein the second D2D subsystem comprises:
a plurality of second D2D PHYs, each second D2D PHY comprising a plurality of data lanes; and
a second elastic buffer configured to aggregate bandwidth from the plurality of second D2D PHYs and provide a single interface between the second die core and the plurality of second D2D PHYs.

11. The system according to claim 10, wherein the D2D link is configured to couple the plurality of first D2D PHYs to the plurality of second D2D PHYs for bidirectional communication between the first die and the second die.

12. A method for inter-die communication in a system comprising a first die and a second die, the method comprising:
receiving, at a first elastic buffer of a first die-to-die (D2D) subsystem, data from a first die core;
distributing the data from the first elastic buffer to a plurality of first D2D physical interfaces (PHYs), each first D2D PHY comprising a plurality of data lanes;
transmitting the data via the plurality of first D2D PHYs to a second D2D subsystem of the second die through a D2D link;
detecting a failure of at least one data lane in one of the plurality of first D2D PHYs; and
compensating for the failed data lane by redistributing data transmission across remaining functional data lanes in the plurality of first D2D PHYs, wherein the first elastic buffer aggregates bandwidth from the plurality of first D2D PHYs to maintain a total aggregate bandwidth that meets a bandwidth requirement of the first die core.

13. The method according to claim 12, wherein compensating for the failed data lane comprises increasing an operating frequency of the remaining functional data lanes in the plurality of first D2D PHYs.

14. The method according to claim 13, wherein increasing the operating frequency comprises performing a frequency sweep to determine a maximum operating frequency that maintains functionality of the remaining functional data lanes.

15. The method according to claim 12, wherein receiving the data at the first elastic buffer comprises writing the data at a first clock frequency associated with the first die core, and wherein distributing the data from the first elastic buffer comprises reading the data at a second clock frequency associated with the plurality of first D2D PHYs, wherein the first clock frequency and the second clock frequency differ in at least one of phase and frequency.

16. The method according to claim 12, further comprising compensating for a complete failure of one of the plurality of first D2D PHYs by increasing bandwidth of remaining functional first D2D PHYs in the plurality of first D2D PHYs.

17. A die-to-die (D2D) subsystem for a die in a multi-die system, the D2D subsystem comprising:
a plurality of D2D physical interfaces (PHYs), each D2D PHY comprising a plurality of data lanes configured to transmit data to another die;
an elastic buffer for transmission configured to receive data from a die core and provide the data to the plurality of D2D PHYs; and
an elastic buffer for reception configured to receive data from the plurality of D2D PHYs and provide the data to the die core;
wherein the elastic buffer for transmission is configured to aggregate bandwidth from the plurality of D2D PHYs such that the plurality of D2D PHYs operate as a single endpoint for the die core, and wherein the D2D subsystem is configured to compensate for a failure of at least one data lane by redistributing data transmission across remaining functional data lanes in the plurality of D2D PHYs.

18. The D2D subsystem according to claim 17, wherein each of the plurality of D2D PHYs is configured to operate at an independent clock frequency based on a negotiated operating bandwidth.

19. The D2D subsystem according to claim 18, wherein the D2D subsystem is configured to compensate for the failure of the at least one data lane by increasing an operating frequency of the remaining functional data lanes.

20. The D2D subsystem according to claim 17, wherein the D2D subsystem is configured to compensate for a complete failure of one of the plurality of D2D PHYs by increasing bandwidth of remaining functional D2D PHYs in the plurality of D2D PHYs.
